(19) United States
(12) Patent Application Publication
(10) Pub. No.: US 2006/0108441 A1
(43) Pub. Date: May 25, 2006

(54) Fuel injection valve and manufacturing method for the same

(75) Inventors: Toyoji Nishiwaki, Kariya-city (JP); Nobuo Ota, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/285,079

(22) Filed: Nov. 23, 2005

(30) Foreign Application Priority Data
Nov. 25, 2004 (JP) 2004-340438

(51) Int. Cl. F02M 47/02; B05B 1/34; F02M 63/00; B05B 1/30

(52) U.S. Cl. 239/88; 239/533.2; 239/533.14

(57) ABSTRACT

A fuel injection valve includes a valve body, a nozzle plate, and a weld portion. The valve body includes an axial end portion that has an opening and an inner periphery connecting with each other. The inner periphery is a substantially conical surface defining a valve seat. The nozzle plate is provided to the axial end portion of the valve body. The valve body and the nozzle plate define a boundary portion therebetween. The nozzle plate has a plurality of nozzle holes, through which an end surface of the nozzle plate on a side of the opening of the valve body communicates with an end surface of the nozzle plate on a side opposite to the valve body. The weld portion connects the valve body with the nozzle plate. The weld portion extends from an outer circumferential periphery of the boundary portion to an inner side in a radial direction of the valve body.

### CROSS REFERENCE TO RELATED APPLICATIONS

This application is based on and incorporates herein by reference Japanese Patent Application No. 2004-340438 filed on Nov. 25, 2004.

### FIELD OF THE INVENTION

The present invention relates to a fuel injection valve, which is used for an internal combustion engine, and a manufacturing method for the fuel injection valve.

### BACKGROUND OF THE INVENTION

A fuel injection valve needs to have a high performance for atomizing fuel to reduce a toxic substance from exhaust gas and to improve fuel efficiency. Conventionally, a nozzle plate is provided to a tip end of a valve body in a fuel injection valve for producing atomizing performance of fuel. The valve body has a valve seat. The nozzle plate has a nozzle hole, through which fuel is injected. In this structure, when the diameter of the nozzle hole is the same, as the thickness of the nozzle plate decreases, the atomizing performance can be enhanced. By contrast, when the thickness of the nozzle plate decreases, strength of the nozzle plate decreases. High-pressure fuel is supplied to an inlet of the nozzle hole of the nozzle plate through the valve body, so that the fuel is injected into the engine. As the thickness of the nozzle plate decreases, the nozzle plate may deform to the side of the engine due to pressure of the fuel. According to JP-A-2004-60519 (US 2004 0069873 A1), the nozzle plate integrally connects to a cylindrical portion that covers the outer circumferential periphery of the valve body. The cylindrical portion is welded to the valve body, so that the nozzle plate is secured to the valve body. The fuel injection valve has a nozzle holder on the opposite side of the valve body with respect to the nozzle plate. The nozzle holder extends to the radially inner side, so that the nozzle holder supports the nozzle plate from the axially opposite side of the valve body. In this structure, the thickness of the nozzle plate increases excluding the bottom portion, in which the nozzle hole is formed. In addition, the nozzle plate is supported by the nozzle holder, so that the nozzle plate has strength resistive to pressure of fuel.

However, in this structure, the pressure of fuel is applied to the entire surface of the bottom portion of the nozzle plate. The nozzle hole is formed in the bottom portion of the nozzle plate. Therefore, the area of the surface, in which pressure of fuel is applied, increases in the nozzle plate. In addition, the thickness of the bottom portion, in which the nozzle hole is formed, becomes small in the nozzle plate, even though the thickness of the nozzle plate becomes large excluding the bottom portion. The bottom portion needs to be accurately formed in a thin recessed shape. As a result, a process and a cost increase for manufacturing the nozzle plate.

Furthermore, the thickness of the nozzle plate, particularly the thickness of the cylindrical portion may change due to modification in design of the fuel injection valve. In this case, a condition of welding between the nozzle plate and the valve body may change. Accordingly, the condition of welding needs to be set to respective nozzle plate for each design. As a result, versatility decreases.

Furthermore, the nozzle holder radially protrudes inwardly to the vicinity of the nozzle hole for supporting the nozzle plate. In this structure, fuel is apt to remain in the vicinity of the nozzle hole. Besides, the nozzle holder supports the nozzle plate from the outer circumferential periphery of the nozzle plate. In this structure, the thermal capacity increases in the vicinity of the nozzle plate. As a result, fuel remaining around the nozzle hole may be solidified by being exposed to high-temperature gas in a combustion chamber of the engine. Thus, the remaining fuel may become deposit stacking around the nozzle hole.

### SUMMARY OF THE INVENTION

In view of the foregoing and other problems, it is an object of the present invention to produce a fuel injection valve and a manufacturing method of the fuel injection valve, the fuel injection valve having a strong nozzle plate, around which deposit can be restricted from stacking.

According to one aspect of the present invention, a fuel injection valve includes a valve body, a nozzle plate, and a weld portion. The valve body includes an axial end portion in an axial direction of the valve body. The axial end portion has an opening and an inner periphery. The opening connects with the inner periphery. The inner periphery is a substantially conical surface defining a valve seat. The nozzle plate is provided to the axial end portion of the valve body. The valve body and the nozzle plate form a boundary portion therebetween. The nozzle plate has a plurality of nozzle holes, through which an end surface of the nozzle plate on a side of the opening of the valve body communicates with an end surface of the nozzle plate on a side opposite to the valve body. The weld portion that connects the valve body with the nozzle plate. The weld portion extends from an outer circumferential periphery of the boundary portion, which is between the valve body and the nozzle plate, to an inner side in a radial direction of the valve body.

Alternatively, a nozzle plate has a substantially flat surface, which connects to the axial end portion of the valve body. The boundary portion includes the substantially flat surface of the nozzle plate. The nozzle plate has at least one nozzle hole that is a through hole, through which the opening of the valve body communicates with an end surface of the nozzle plate on a side opposite to the valve body. The weld portion extends from an outer circumferential periphery of the boundary portion, which is between the nozzle plate and the valve body. The weld portion extends to an inner side in a radial direction of the valve body.

A manufacturing method for the fuel injection valve includes welding the valve body with the nozzle plate from an outer side in a radial direction of the valve body to a surface, in which the valve body connects with the nozzle plate.

Alternatively, a manufacturing method for a fuel injection valve includes the following processes. An axial end face of the valve body is connected with an axial end face of the nozzle plate such that a plurality of nozzle holes of the nozzle plate communicates with an opening of the valve body. The axial end face of the valve body is welded with an outer circumferential periphery of the axial end face of the nozzle plate from an outer side in a radial direction of the valve body.

Alternatively, a manufacturing method for a fuel injection valve includes the following processes. A substantially flat surface of a nozzle plate is connected to an axial end surface of a valve body having an opening at a predetermined position such that a plurality of nozzle holes of the nozzle plate communicates with the opening of the valve body. An outer circumferential periphery of the substantially flat surface of the nozzle plate is welded with the valve body from an outer side in a radial direction of the valve body.

In the above structures and methods, force applied from high-pressure fuel onto the nozzle plate can be restricted, so that the thickness of the nozzle plate can be restricted, while the strength of the nozzle plate is maintained. Thus, atomization in the fuel injection can be enhanced by restricting the thickness of the nozzle plate. Therefore, a toxic substance may be reduced in exhaust gas, and fuel efficiency may be improved. Furthermore, the nozzle plate need not special manufacturing work such as reducing the thickness of the nozzle plate in a extremely limited position. Therefore, the structure of the nozzle plate may be simplified, and manufacturing work may be reduced.

### BRIEF DESCRIPTION OF THE DRAWINGS

The above and other objects, features and advantages of the present invention will become more apparent from the following detailed description made with reference to the accompanying drawings. In the drawings:

FIG. 1 is a partially cross sectional side view showing an injector according to a first embodiment of the present invention;

FIG. 2 is a partially cross sectional side view showing a nozzle plate of the injector according to the first embodiment;

FIG. 3 is a partially cross sectional side view showing an internal combustion engine having the injector according to the first embodiment;

FIG. 4 is a partially cross sectional side view showing the nozzle plate and a welder according to the first embodiment;

FIG. 5 is a graph showing a relationship between the diameter φ of a pressure receiving surface of the nozzle plate, force F applied to the pressure receiving surface, and strength of the nozzle plate;

FIG. 6 is a partially cross sectional side view showing an example of a nozzle plate of an injector;

FIG. 7 is a partially cross sectional side view showing a nozzle plate of an injector according to a second embodiment of the present invention;

FIG. 8 is a partially cross sectional side view showing a nozzle plate of an injector according to a third embodiment of the present invention;

FIG. 9 is a partially cross sectional side view showing a nozzle plate of an injector according to a fourth embodiment of the present invention; and

FIG. 10 is a partially cross sectional side view showing a nozzle plate of an injector according to a fifth embodiment of the present invention;

### DETAILED DESCRIPTION OF PREFERRED EMBODIMENTS

### First Embodiment

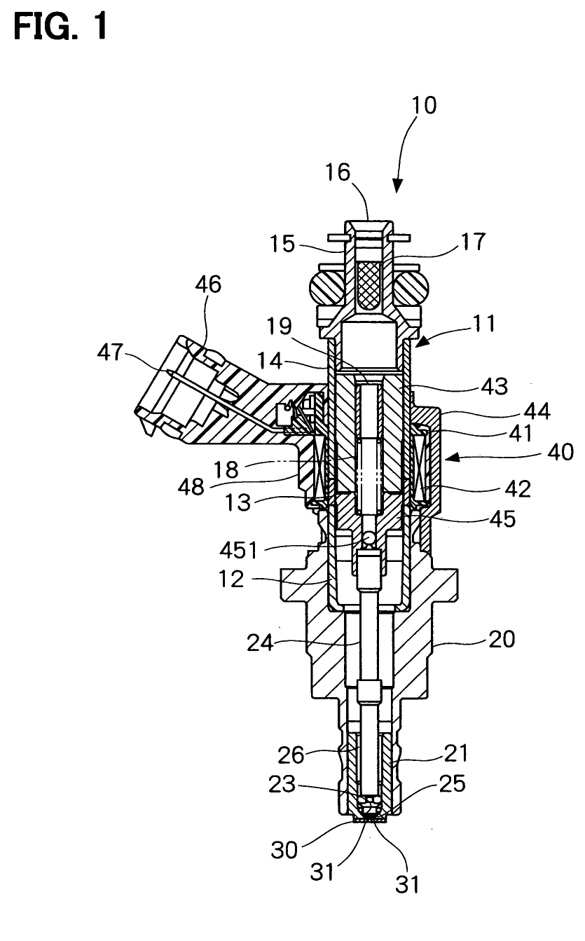

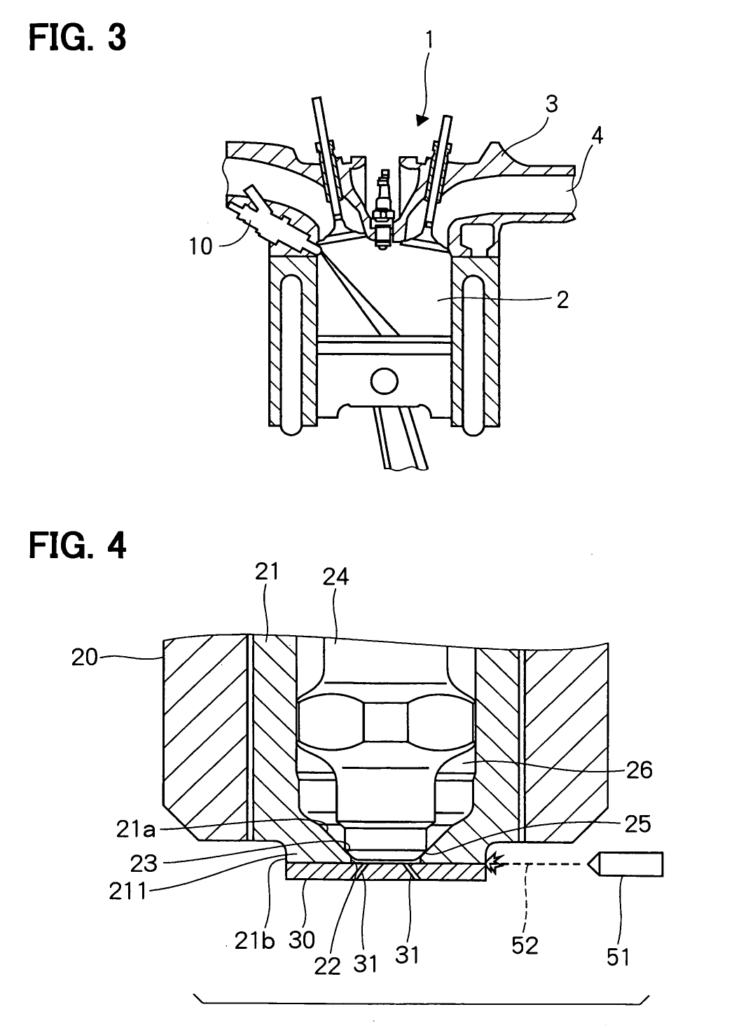

A fuel injection valve (injector) 10 shown in FIG. 1 is mounted to an internal combustion engine 1 shown in FIG. 3. Specifically, as shown in FIG. 3, the injector 10 is mounted to a cylinder head 3, which has a combustion chamber 2 of the internal combustion engine 1. The engine 1 may be a direct fuel-injection gasoline engine, in which fuel is directly injected into the combustion chamber 2. The engine 1 may be a port-injection engine. When the engine 1 is a port-injection engine, the injector is mounted to a cylinder head 3, which has an intake port 4. The injector 10 may be used in a diesel engine or in other various kinds of engines.

As shown in FIG. 1, the injector 10 has a housing 11, which is in a cylindrical shape. The housing has a first magnetic portion 12, a non-magnetic portion 13, and a second magnetic portion 14. The non-magnetic portion 13 restricts the first magnetic portion 12 from causing magnetically short circuit relative to the second magnetic portion 14. The first magnetic portion 12, the non-magnetic portion 13, and the second magnetic portion 14 are connected integrally to each other using laser welding, for example. Alternatively, a cylindrical housing may be formed of a magnetic material or a non-magnetic material, and thermal treatment may be performed to the cylindrical housing, so that the cylindrical housing can be changed to be partially non-magnetic or to be partially magnetic.

The housing 11 has first axial end, to which an inlet member 15 is provided. The inlet member 15 is press-inserted into the inner circumferential periphery of the housing 11. The inlet member 15 has a fuel inlet 16. A fuel pump (not shown) supplies fuel into the fuel inlet 16. The fuel flows from the fuel inlet 16 to the inside of the housing 11 through a fuel filter 17. The fuel filter 17 removes foreign matters contained in fuel.

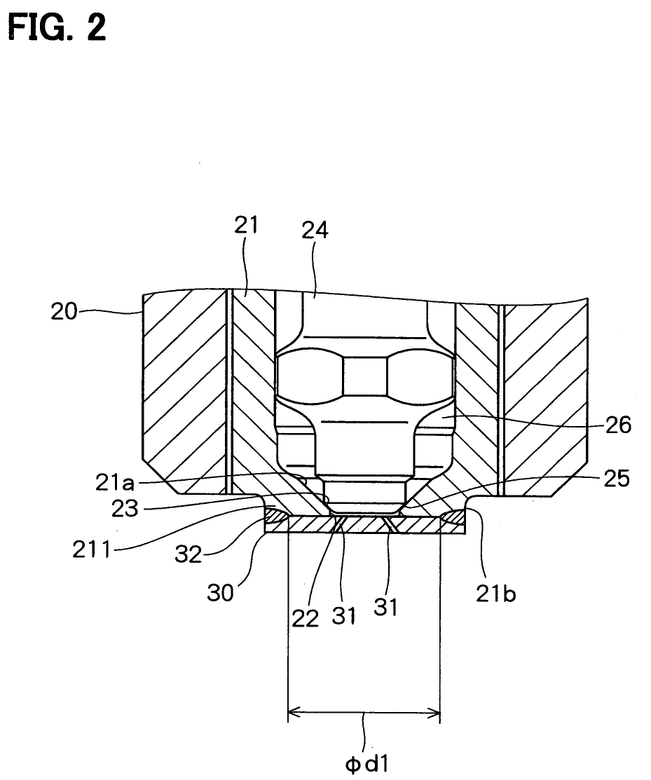

The housing has the other end, to which a nozzle holder 20 is provided. The nozzle holder 20 is in a cylindrical shape. The nozzle holder 20 accommodates a valve body 21, which is in a cylindrical shape. As shown in FIG. 2, the valve body 21 has an opening 22 on the side axially opposite to the fuel inlet 16. The valve body 21 is secured to the nozzle holder 20 by press-insertion, welding, or the like. The valve body 21 has a conical inner surface 21a, which becomes radially small toward the opening 22 in the tip end of the valve body 21, so that the conical inner surface 21a defines a valve seat 23. A nozzle plate 30 is provided to the tip end (first axial end portion) of the valve body 21 on the side of the opening 22. The nozzle plate 30 has a nozzle hole 31, which is a through hole passing substantially in the thickness direction of the nozzle plate 30. The surface of the nozzle plate 30 on the side of the valve body 21 communicates with the surface of the nozzle plate 30 on the opposite side of the valve body 21 through the nozzle hole 31.

As referred to FIG. 1, the housing 11, the nozzle holder 20, and the valve body 21 accommodate a needle 24 therein, such that the needle 24 can axially move back and forth. The needle 24 is arranged substantially coaxially relative to the valve body 21. The needle 24 has a seal portion 25 on the opposite side of the first axial end of the housing 11, to which the fuel inlet 16 is provided. The seal portion 25 can make contact with the valve seat 23 formed in the valve body 21. The needle 24 forms a fuel passage with the valve body 21 therebetween, such that fuel flows through the fuel passage.

As referred to FIG. 1, the injector 10 has a driving portion 40 that operates the needle 24. The driving portion 40 includes a spool 41, a coil 42, a fixed core 43, a plate housing 44, and a movable core 45. The spool 41 is arranged on the outer circumferential side of the housing 11. The spool 41 is formed of resin to be in a cylindrical shape. A coil 42 is wound around the outer circumferential periphery of the spool 41. The coil 42 electrically connects with a terminal 47 of the connector 46. The fixed core 43 is provided inside the inner periphery of the coil 42 via the housing 11. The fixed core 43 is formed of magnetic material such as iron to be in a cylindrical shape. The fixed core 43 is secured to the inner periphery of the housing 11 by press-insertion or the like. The plate housing 44 serves as a magnetic member. The plate housing 44 surrounds the outer circumferential periphery of the coil 42. The outer peripheries of the spool 41 and the coil 42 are covered with a resinous mold 48, which is integrally formed with the connector 46.

The movable core 45 is arranged in the inner periphery of the housing 11 such that the movable core 45 can axially move back and forth. The movable core 45 is formed of a magnetic material such as iron to be in a cylindrical shape. The axial end of the movable core 45 on the opposite side of the fixed core 43 integrally connects with the needle 24. The axial end of the movable core 45 on the side of the fixed core 43 makes contact with a spring 18. The spring 18 serves as a biasing member. The spring 18 has one axial end, which makes contact with the movable core 45. The spring 18 has the other axial end that makes contact with an adjusting pipe 19, which is press-inserted into the fixed core 43. The spring has resilience to extend in the axial direction thereof. Therefore, the movable core 45 and the needle 24 are pressed in the direction, in which the needle 24 seats onto the valve seat 23, by the spring 18. The adjusting pipe 19 is press-inserted into the fixed core 43. Biasing force of the spring 18 can be controlled by modifying degree of press-insertion of the adjusting pipe 19 relative to the fixed core 43. When the coil 42 is not supplied with electricity, the movable core 45 and the needle 24 are pressed to the side of the valve seat 23, so that the seal portion 25 seats onto the valve seat 23.

Next, a structure around the nozzle plate 30 is described.

As referred to FIG. 2, the nozzle plate 30 is mounted to the tip end of the valve body 21 on the opposite side of the housing 11. The nozzle plate 30 is formed in a thin plate shape. The nozzle plate 30 is secured to the end of the valve body 21 on the opposite side of the housing 11. The valve body 21 has the opening 22 in the axial end thereof on the side of the nozzle plate 30. That is, the valve body 21 has the opening 22 in the axial end thereof on the opposite side of the fuel inlet 16. The opening 22 is in a substantially circular shape. The substantially conical inner surface 21a defines the valve seat 23. The end of the inner surface 21a on the opposite side of the housing 11 connects to the opening 22.

The tip end of the valve body 21 on the side of the opening 22 has a protruding portion 211. The protruding portion 211 of the valve body 21 has the diameter that is greater than the portion of the valve body 21 excluding the protruding portion 211. This valve body 21 excluding the protruding portion 211 guides the movement of the needle 24. The protruding portion 211 of the valve body 21 forms a boundary portion with the nozzle plate 30 therebetween. The valve body 21 forms a weld portion 32 with the nozzle plate 30 therebetween, such that the valve body 21 connects with the nozzle plate 30 via the weld portion 32. The weld portion 32 extends from the radially outer side of the valve body 21 and the nozzle plate 30 to the radially inner side thereof in the radial direction thereof. The weld portion 32 continuously extends in the circumferential direction of the valve body 21 and the nozzle plate 30. The valve body 21 connects with the nozzle plate 30 via the weld portion 32 in a predetermined range from the radially outer side to the radially inner side in the radial direction thereof, so that the valve body 21 and the nozzle plate 30 do not form a space substantially therebetween. That is, the weld portion 32 extends to the radially inner side with respect to the outer circumferential periphery 21b of the protruding portion 211 of the valve body 21.

As shown in FIG. 4, the valve body 21 and the nozzle plate 30 are welded to each other from the outer peripheral side, i.e., radially outer side of the boundary surface, via which the valve body 21 connect with the nozzle plate 30. That is, the valve body 21 and the nozzle plate 30 are welded to each other from an extension line on the radially outer side of the boundary surface. The valve body 21 is welded to the nozzle plate 30 using laser welding, for example. A welder 51 is installed on the extension line on the radially outer side of the boundary surface between the valve body 21 and the nozzle plate 30. When the valve body 21 is welded to the nozzle plate 30 using laser welding, the welder 51 radiates a laser beam to the boundary surface between the valve body 21 and the nozzle plate 30. Thus, the axial end of the valve body 21 on the side of the nozzle plate 30 welds and connects to the axial end of the nozzle plate 30 on the side of the valve body 21. The welded portion is cooled, so that the valve body 21 and the nozzle plate 30 form the weld portion 32 therebetween.

The valve body 21 and the nozzle plate 30 form the weld portion 32 therebetween, so that a space (gap) is restricted from being formed between the valve body 21 and the nozzle plate 30 radially in the predetermined range from the outer circumferential periphery to the radially inner side thereof.

High-pressure fuel passing along the valve seat 23 applies pressure to the radially inner side of the nozzle plate 30 with respect to the weld portion 32. That is, as referred to FIG. 2, the diameter φ1 of a pressure receiving surface of the nozzle plate 30 corresponds to the inner diameter of the weld portion 32.

As referred to FIG. 3, when the injector 10 is used in a direct fuel-injection gasoline engine 1, the injector 10 injects fuel to high-pressure air in the combustion engine 2. Therefore, fuel supplied to the injector 10 is extremely high, because the fuel is injected into the combustion chamber 2 in a high-pressure condition. Accordingly, the nozzle plate 30 is applied with large force from the high-pressure fuel remaining on the side of the valve seat 23. Pressure of fuel injected from the injector 10 is defined as Pf, for example, and the pressure receiving surface of the nozzle plate 30 has the diameter φd. In this case, the nozzle plate 30 is applied with force F by fuel injection, and the force F is calculated by the following formula.
F=(φd/2)² ×π×Pf

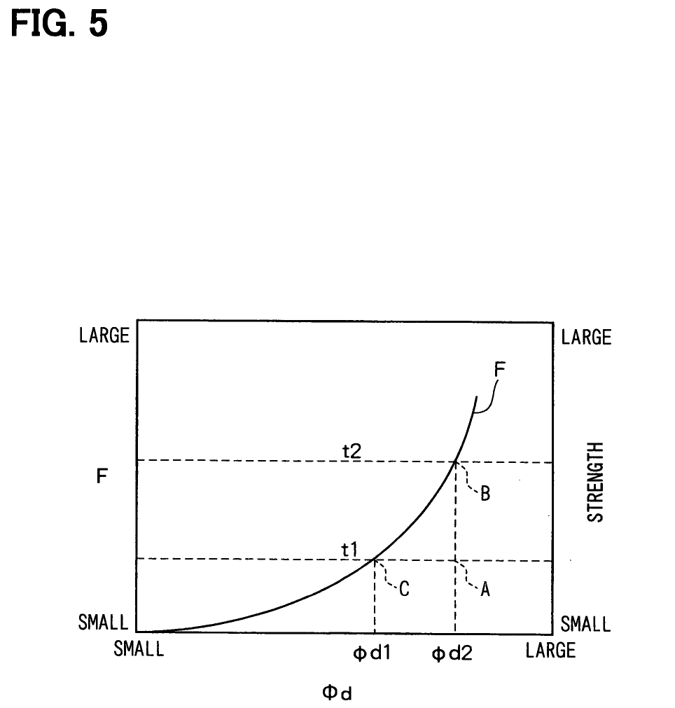

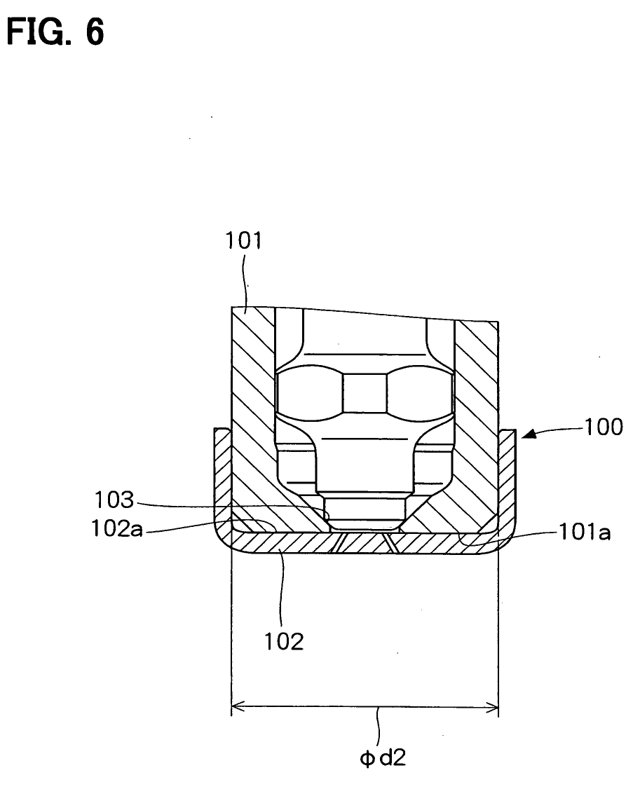

As shown in FIG. 5, as the inner diameter φd of the pressure receiving surface of the nozzle plate 30 increases, the force F applied from fuel to the nozzle plate 30 increases. As shown in FIG. 6, an example of an injector has a nozzle plate 100, which is formed in a bottomed cylindrical shape. The nozzle plate 100 has a bottom portion 102, which covers a valve body 101. In this structure, fuel passing along a valve seat 103 intrudes into a space formed between an axial end surface 101a of the valve body 101 and a surface 102a of the bottom portion 102 of the nozzle plate 100 on the side of the valve body 101. The pressure receiving surface of the nozzle plate 30 has the inner diameter φd2 that corresponds to the inner diameter of the nozzle plate 30. As a result, as shown in FIG. 5, when the thickness of the nozzle plate 100 is set at thickness t1, which is relatively thin, and when the inner diameter is φd2, strength of the nozzle plate 100 shown by A becomes less than the force F applied from fuel. Thus, the nozzle plate 100 cannot has sufficient strength. Accordingly, in the example of the injector shown in FIG. 6, the thickness of the nozzle plate 100 needs to be set at t2 for securing sufficient strength of the nozzle plate 100 as shown by B.

By contrast, in this embodiment, as referred to FIG. 2, the weld portion 32 is formed between the protruding portion 211 of the valve body 21 and the nozzle plate 30, so that the pressure receiving surface of the nozzle plate 30 is located on the inner peripheral side with respect to the weld portion 32. Therefore, the inner diameter φd1 of the pressure receiving surface of the nozzle plate 30 corresponds to the inner diameter of the weld portion 32. Particularly, the nozzle plate 30 is arranged to the protruding portion 211 of the vale body 21, so that the inner diameter of the weld portion 32 further decreases. In this structure, the pressure receiving surface has the inner diameter φd1, and as referred to FIG. 5, even when the thickness of the nozzle plate 30 is set at t1, which is smaller than t2, the nozzle plate 30 can produce sufficient strength shown by C, which can be resistive enough against the fuel pressure. Thus, the strength of the nozzle plate 30 can be secured. As a result, in this embodiment, the nozzle plate 30 can be reduced in thickness.

Next, an operation of the injector 10 is described.

The fixed core 43 and the movable core 45 do not generate magnetic attraction force therebetween, when electricity is terminated from being supplied to the coil 42. In this condition, both the movable core 45 and the needle 24 are biased by pressing force of the spring 18 to move to the opposite side of the fixed core 43. As a result, when the coil 42 is not supplied with electricity, the seal portion 25 of the needle 24 seats onto the valve seat 23, so that fuel is restricted from being injected through the nozzle hole 31.

When the coil 42 is supplied with electricity, the coil generates magnetic field, so that magnetic flux flows through the plate housing 44, the nozzle holder 20, the first magnetic portion 12, the movable core 45, the fixed core 43, and the second magnetic portion 14, thereby forming a magnetic circuit thereamong. Thus, the fixed core 43 and the movable core 45 generate magnetic attractive force therebetween. When the magnetic attractive force between the fixed core 43 and the movable core 45 becomes greater than the resilience of the spring 18, the movable core 45 and the needle 24 integrally move to the side of the fixed core 43. Thus, the seal portion 25 of the needle 24 lifts from the valve seat 23.

Fuel flows into the injector 10 through the fuel inlet 16, and the fuel flows through the fuel filter 17, the inner spaces of the inlet member 15, the adjusting pipe 19, and the movable core 45. The fuel further flows through a communication hole 451, the space between the housing 11 and the movable core 45, and the space between the needle 24 and the nozzle holder 20, so that the fuel flows into a fuel passage 26. The inside of the movable core 45 communicates with the outside of the movable core 45 through the communication hole 451. The fuel passing through the fuel passage 26 flows into the nozzle hole 31 through the space, which formed is between the valve seat 23 and the seal portion 25, and the opening 22. Thus, the fuel is injected through the nozzle hole 31.

When electricity supplied to the coil 42 is terminated, the attractive force between the fixed core 43 and the movable core 45 disappears. In this condition, the movable core 45 and the needle 24 are integrally moved to the opposite side of the fixed core 43 by resilience of the spring 18. Therefore, the seal portion 25 seats onto the valve seat 23 again, so that fuel is restricted from flowing between the fuel passage 26 and the nozzle hole 31. Thus, fuel injection is terminated.

In this embodiment, the valve body 21 and the nozzle plate 30 are welded from the radially outer position thereof on the extension line of the surface, via which the valve body 21 makes contact with the nozzle plate 30. In this method, the weld portion 32 is formed to extend from the radially inner side to the radially outer side between the valve body 21 and the nozzle plate 30. The weld portion 32 extends from the outer circumferential periphery 21b of the protruding portion 211 of the valve body 21 to the radially inner side in the protruding portion 211 of the valve body 21, so that the inner diameter φd1 of the pressure receiving surface of the nozzle plate 30 decreases. As a result, the force applied from the high-pressure fuel onto the nozzle plate 30 is reduced, so that the thickness of the nozzle plate 30 can be reduced, while the strength of the nozzle plate 30 is maintained. Thus, atomization in the fuel injection can be enhanced by reducing the thickness of the nozzle plate 30. Therefore, a toxic substance can be reduced in exhaust gas, and fuel efficiency can be improved. Furthermore, the nozzle plate 30 does not need special manufacturing work such as reducing the thickness thereof around the nozzle plate 31. Therefore, the structure of the nozzle plate 30 can be simplified, and manufacturing work can be reduced.

In this embodiment, the valve body 21 connects to the nozzle plate 30 by welding from the radially outer position on the extension line of the boundary surface between the valve body 21 and the nozzle plate 30. Therefore, the valve body 21 can be easily welded to the nozzle plate 30, regardless of the thickness of the nozzle plate 30. In this method, output power of the welder 51 need not be adjusted in accordance with the thickness of the nozzle plate 30, for example. Therefore, a welding facility need not be modified for every design of the nozzle plate 30, so that versatility of the welding facility can be enhanced by commonly using the welding facility for manufacturing various kinds of injectors.

In this embodiment, only the thin plate-shaped nozzle plate 30 is provided to the tip end of the valve body 21. Therefore, a protruding portion or another member is not provided in the vicinity of the nozzle hole 31 of the nozzle plate 30. The nozzle plate 30 is in a plate shape having a substantially uniform thickness, so that projections and depressions can be reduced in the vicinity of the nozzle hole 31. Furthermore, the nozzle plate 30 is provided to the protruding portion 211, which has the small diameter in the valve body 21, so that a thermal capacity decreases in the vicinity of the nozzle plate 30, thereby restricting fuel from remaining around the nozzle hole 31. As a result, even when fuel remaining around the nozzle hole 31 is exposed to high-temperature combustion gas in the combustion chamber 2, the fuel around the nozzle hole 31 can be restricted from solidifying. Thus, deposit can be restricted from stacking around the nozzle hole 31.

### Second Embodiment

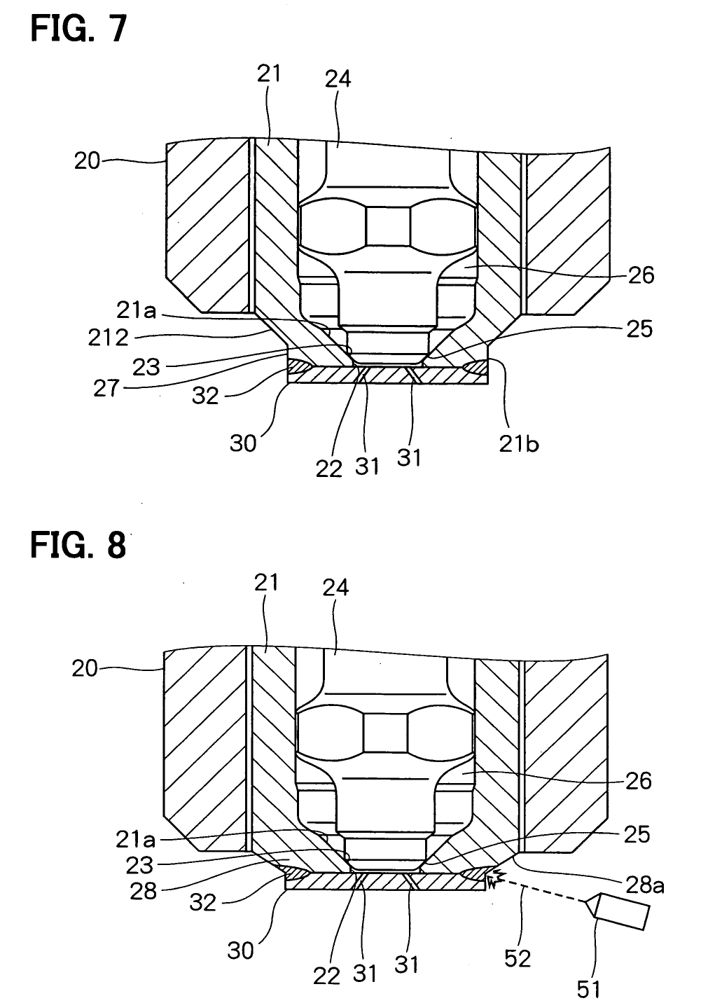

In this embodiment, as shown in FIG. 7, the tip end of the valve body 21 on the side of the nozzle plate 30 has a small-diameter portion 27. The small-diameter portion 27 has the diameter that is small compared with the portion of the valve body 21 other than the small-diameter portion 27. That is, the small-diameter portion 27 has a structure similar to that of the protruding portion in the first embodiment. The valve body 21 has a taper portion 212 between a portion, which guides the needle 24, and the small-diameter portion 27. The small-diameter portion 27 and the taper portion 212 are provided to the valve body 21, so that the volume of the tip end of the valve body 21 reduces. Specifically, the end of the valve body 21 on the side of the nozzle plate 30 reduces in volume. Thus, thermal capacity of the valve body 21 reduces, so that deposit can be restricted from stacking around the nozzle hole 31.

In this embodiment, the outer diameter of the small-diameter portion 27 is set to be substantially the same as the outer diameter of the nozzle plate 30. Therefore, the valve body 21 can be easily welded to the nozzle plate 30 from the radially outer position thereof.

### Third and Fourth Embodiments

In the third embodiment, as shown in FIG. 8, the end of the valve body 21 on the side of the nozzle plate 30 has a thick portion 28, so that the valve body 21 has a sufficient thickness on the side of the nozzle plate 30. In this structure, the strength of the valve body 21 can be enhanced. In this embodiment, the thick portion 28 of the valve body 21 has a substantially conical outer peripheral surface 28a. The nozzle plate 30 is provided to the tip end of the thick portion 28. In this structure, when the valve body 21 is welded to the nozzle plate 30, the welder 51 radiates the laser beam from the lower position with respect to the boundary surface, via which the valve body 21 makes contact with the nozzle plate 30, in FIG. 8 toward the center axis thereof. Thus, the weld portion 32 is formed from the outer circumferential periphery of the nozzle plate 30 to the radially inner side thereof.

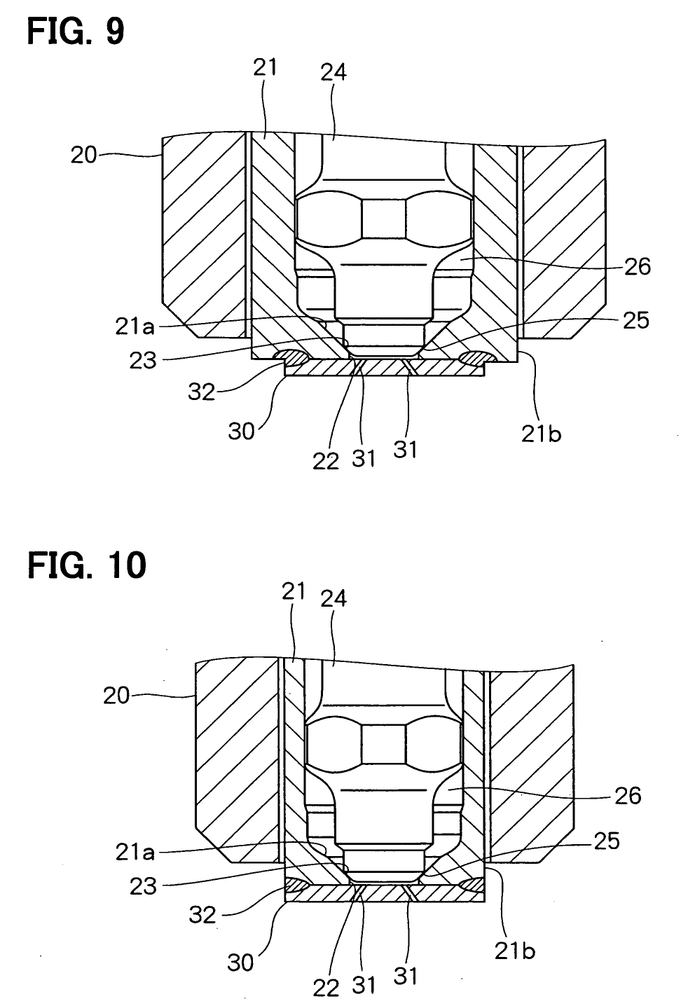

In the forth embodiment, as shown in FIG. 9, the valve body 21 has the outer diameter that is substantially uniform to the axial end portion thereof on the side of the nozzle plate 30. That is, the outer diameter of the valve body 21 does not decrease in the axial end portion thereof on the side of the nozzle plate 30. In this structure, the valve body 21 has a simple shape, such that the valve body 21 does not need manufacturing such as forming a stepwise surface and/or a taper surface on the outer circumferential periphery thereof. Therefore, the manufacturing work of the valve body 21 can be simplified. Furthermore, the outer diameter of the valve body 21 is substantially uniform in the axial direction thereof, so that the thickness of the valve body 21 increases on the side of the nozzle plate 30. Thus, the strength of the valve body 21 can be enhanced. In this embodiment, the weld portion 32 is formed from the outer circumferential periphery of the nozzle plate 30 to the radially inner side thereof, similarly to the third embodiment.

### Fifth Embodiment

In the fifth embodiment, as shown in FIG. 10, the valve body 21 has the outer diameter that is substantially uniform to the axial end portion thereof on the side of the nozzle plate 30. The needle 24 in this embodiment has the outer diameter that is smaller than the needle 24 in the above embodiments. Therefore, the outer diameter of the valve body 21 and the outer diameter of the nozzle holder 20 are reduced in this embodiment, so that thermal capacity of the portion in the vicinity of the nozzle plate 30 decreases in the valve body 21. In this structure, the valve body 21 and the needle 24 can be downsized, and deposit can be restricted from stacking around the nozzle hole 31.

The above structures of the embodiments can be combined as appropriate.

Various modifications and alternations may be diversely made to the above embodiments without departing from the spirit of the present invention.

What is claimed is:

1. A fuel injection valve comprising:
a valve body that includes an axial end portion in an axial direction of the valve body, the axial end portion having an opening and an inner periphery, the opening connecting with the inner periphery, the inner periphery being a substantially conical surface defining a valve seat;
a nozzle plate that is provided to the axial end portion of the valve body, the valve body and the nozzle plate forming a boundary portion therebetween, the nozzle plate having a plurality of nozzle holes, through which an end surface of the nozzle plate on a side of the opening of the valve body communicates with an end surface of the nozzle plate on a side opposite to the valve body; and
a weld portion that connects the valve body with the nozzle plate, the weld portion extending from an outer circumferential periphery of the boundary portion, which is between the valve body and the nozzle plate, to an inner side in a radial direction of the valve body.

2. The fuel injection valve according to claim 1, wherein the weld portion is located on an inner side with respect to an outer circumferential periphery of the valve body in the radial direction of the valve body.

3. The fuel injection valve according to claim 2,
wherein the axial end portion of the valve body on the side of the opening has a protruding portion that has an outer diameter smaller than an outer diameter of the valve body, and
the protruding portion of the valve body forms the boundary portion with the nozzle plate therebetween.

4. The fuel injection valve according to claim 1,
wherein the end surface of the nozzle plate on the side of the opening of the valve body is a substantially flat surface.

5. The fuel injection valve according to claim 1, wherein the nozzle plate is in a substantially flat shape having a substantially uniform thickness in a radial direction of the nozzle plate.

6. A fuel injection valve comprising:
a valve body that includes an axial end portion in an axial direction of the valve body, the axial end portion having an opening and an inner periphery, the opening connecting with the inner periphery, the inner periphery being a substantially conical surface;
a nozzle plate that has a substantially flat surface, which connects to the axial end portion of the valve body, the nozzle plate and the valve body forming a boundary portion therebetween, the boundary portion including the substantially flat surface of the nozzle plate, the nozzle plate having at least one nozzle hole that is a through hole, through which the opening of the valve body communicates with an end surface of the nozzle plate on a side opposite to the valve body; and
a weld portion that extends from an outer circumferential periphery of the boundary portion, which is between the nozzle plate and the valve body, the weld portion extending to an inner side in a radial direction of the valve body.

7. The fuel injection valve according to claim 6, wherein the weld portion is located on an inner side with respect to an outer circumferential periphery of the valve body in the radial direction of the valve body.

8. The fuel injection valve according to claim 7,
wherein the axial end portion of the valve body on the side of the opening has a protruding portion that has an outer diameter smaller than an outer diameter of the valve body, and
the protruding portion of the valve body forms the boundary portion with the nozzle plate therebetween.

9. The fuel injection valve according to claim 6, wherein the nozzle plate is in a substantially flat shape having a substantially uniform thickness in a radial direction of the nozzle plate.

10. A manufacturing method for a fuel injection valve, the fuel injection valve including a valve body that has an axial end portion in an axial direction of the valve body, the axial end portion having an opening and an inner periphery, the opening connecting with the inner periphery, the inner periphery being a substantially conical surface defining a valve seat, the fuel injection valve further including a nozzle plate that is provided to the axial end portion of the valve body, the nozzle plate having a plurality of nozzle holes, through which an end surface of the nozzle plate on a side of the opening of the valve body communicates with an end surface of the nozzle plate on a side opposite to the valve body,
the manufacturing method comprising:
welding the valve body with the nozzle plate from an outer side in a radial direction of the valve body to a surface, in which the valve body connects with the nozzle plate.

11. The manufacturing method according to claim 10, further comprising:
forming a weld portion that extends from an outer circumferential periphery of a boundary portion between the valve body and the nozzle plate to an inner side in a radial direction of the valve body.

12. The manufacturing method according to claim 10, wherein the end surface of the nozzle plate on the side of the opening of the valve body is a substantially flat surface.

13. A manufacturing method for a fuel injection valve, the manufacturing method comprising:
connecting an axial end surface of a valve body with an axial end surface of a nozzle plate such that a plurality of nozzle holes of the nozzle plate communicates with an opening of the valve body; and
welding the axial end surface of the valve body with an outer circumferential periphery of the axial end surface of the nozzle plate from an outer side in a radial direction of the valve body.

14. The manufacturing method according to claim 13, wherein the axial end surface of the nozzle plate on the side of the opening of the valve body is a substantially flat surface.

15. The manufacturing method according to claim 13, wherein the nozzle plate is in a substantially flat shape having a substantially uniform thickness in a radial direction of the nozzle plate.

16. The manufacturing method according to claim 13, wherein the nozzle plate is connected to the valve body such that an outer circumferential periphery of the nozzle plate substantially coincides with an outer circumferential periphery of the valve body.

17. The manufacturing method according to claim 13, further comprising:
forming a weld portion that extends from an outer circumferential periphery of a boundary portion between the valve body and the nozzle plate to an inner side in a radial direction of the valve body.

18. A manufacturing method for a fuel injection valve, the manufacturing method comprising:
connecting a substantially flat surface of a nozzle plate to an axial end surface of a valve body having an opening at a predetermined position such that a plurality of nozzle holes of the nozzle plate communicates with the opening of the valve body; and
welding an outer circumferential periphery of the substantially flat surface of the nozzle plate with the valve body from an outer side in a radial direction of the valve body.

19. The manufacturing method according to claim 18, wherein the nozzle plate is in a substantially flat shape having a substantially uniform thickness in a radial direction of the nozzle plate.

20. The manufacturing method according to claim 18, wherein the nozzle plate is set to the valve body at the predetermined position such that the nozzle plate becomes substantially coaxial with respect to the valve body.

21. The manufacturing method according to claim 18, wherein the nozzle plate is set to the valve body at the predetermined position such that an outer circumferential periphery of the nozzle plate substantially coincides with an outer circumferential periphery of the valve body.

22. The manufacturing method according to claim 18, further comprising:
forming a weld portion that extends from an outer circumferential periphery of a boundary portion between the valve body and the nozzle plate to an inner side in a radial direction of the valve body.
